(19) United States
(12) Patent Application Publication
(10) Pub. No.: US 2013/0062284 A1
(43) Pub. Date: Mar. 14, 2013

(54) DRAINAGE SYSTEM

(71) Applicant: Dimiter Alexiew, Gescher (DE)

(72) Inventor: Dimiter Alexiew, Gescher (DE)

(21) Appl. No.: 13/634,041

(22) PCT Filed: Mar. 10, 2011
(86) PCT No.: PCT/EP2011/001185

§ 371 Date: Nov. 26, 2012

(30) Foreign Application Priority Data
Mar. 11, 2010 (DE) 10 2010 011 129.5

(51) Int. Cl. C02F 1/44

(52) U.S. Cl. CPC C02F 1/444
USPC 210/650; 210/322

(57) ABSTRACT

A system for draining sludge is provided using water-permeable hoses which are closed at both ends and filled with sludge. A first, lower row of sludge-filled hoses located parallel to one another, and one beside the other, has arranged on it at least a second row of sludge-filled hoses located parallel to one another, and one beside the other. The second row can have arranged on it a third, fourth or further row of sludge-filled hoses. On the upper side of each row which bears at least one further row of sludge-filled hoses, drainage pipes, which extend over the length of the hoses, are arranged in the upwardly open channels, which are formed by in each case two sludge-filled hoses located one beside the other. The hoses have a diameter of 0.4 to 1.6 m and a length of at least 10 m.

The invention relates to a system for draining sludge by means of water-permeable hoses, in particular made of geotextile material.

In technology, the sludge state is a state which often occurs in physical, chemical and biological processes. In particular in ore-beneficiation plants, in paper production, in the cleaning of coal and the like, huge quantities of sludge have to be drained in order for it to be possible for the compacted material to be better utilized or deposited.

In order to drain sludge, which contains more than 45% water, it is known for the sludge to be pumped into long hoses or containers made of geotextile fabric, and of 2 to 5 m in diameter, and to be stored until the water content of more than approximately 45% has drained off on account of gravitational force. Very large storage surface areas and months of storage time are required for this drainage operation.

It is an object of the invention to provide a system for draining sludge by means of water-permeable hoses in which drainage takes up less time and less storage surface area. It is also intended to provide a method in which drainage by means of gravitational force takes place in a shorter period of time and over a smaller surface area.

These objects are achieved by the features of patent claims 1 and 10.

When the initially flat underlying hoses are being filled, they assume a form which is made up of a flat lower wall, a flat upper wall and two semicircular outwardly curved side walls. If two sludge-filled hoses located parallel to one another, and one beside the other, have the curved side walls in contact with one another, this gives rise to an upper, upwardly open channel and a lower, downwardly open channel. Drainage pipes can be accommodated in these channels.

Arranging sludge-filled hoses located parallel to one another, and one beside the other, and having a diameter smaller than 1.60 m, in rows stacked one above the other and arranging drainage pipes between the rows of hoses has the great advantage that the drainage path out of the sludge is relatively short. This also means that the time until the sludge has drained is short. Stacking the rows of sludge-filled hoses one above the other allows the storage surface area to be kept small.

Since the diameter of the hoses is smaller than 1.60 m, the hoses can be produced by circular weaving. This has the advantage that longitudinally running seams are avoided and the geotextile material is subjected to loading fully uniformly.

The hoses, at at least one end, are provided with filler nozzles which can be connected to a sludge pump by means of quick-action coupling. The filler nozzles can be shut off. A nonreturn valve is preferably arranged in the filler nozzle.

In the case of long hoses, it is also possible for filler nozzles to be arranged at both ends.

Depending on the diameter of the hoses, it is also possible for the drainage pipes to be of different sizes. The drainage pipes, which extend over the length of the hoses, have, for example, a diameter of 50, 100 or 150 mm and consist of plastics material, in particular of PVC. The drainage pipes have circumferentially distributed openings through which the water can penetrate into the pipe. It may be advantageous for there to be no openings or slots in the lower part of the drainage pipe, in order that the water penetrating in the upper region of the drainage pipe can drain off in a smooth closed channel.

The operations of arranging the hoses and of filling the same with sludge and of arranging the drainage pipes take place one after the other such that a drainage pipe is inserted into an upwardly open channel before a hose in the next row of hoses up ends up located on the drainage pipe.

In order to improve the transverse transportation of the water exiting from the hoses, it may be expedient for spacing elements, in particular (bamboo) sticks, strips of wood, shrubbery or the like running transversely to the hoses, but also stones, gravel or the like, to be provided between the hoses located one upon the other. It is also possible for drainage strips or drainage mats to be arranged between the sludge-filled hoses located one upon the other. The rod-like or elongate spacing elements such as bamboo canes, strips of wood or the like are arranged transversely to the hoses, and therefore the water exiting from the hoses is fed to the drainage pipes over a short path. The extent to which these additional measures are advantageous depends on the local conditions, on the type of sludge and on the processing of the drained sludge.

Since the volume of sludge in the hoses decreases as the sludge is being drained, the hoses in which the sludge has been largely drained can be refilled once or twice with sludge which is to be drained.

Exemplary embodiments of the invention will be described in more detail in the following description with reference to the drawings, in which:

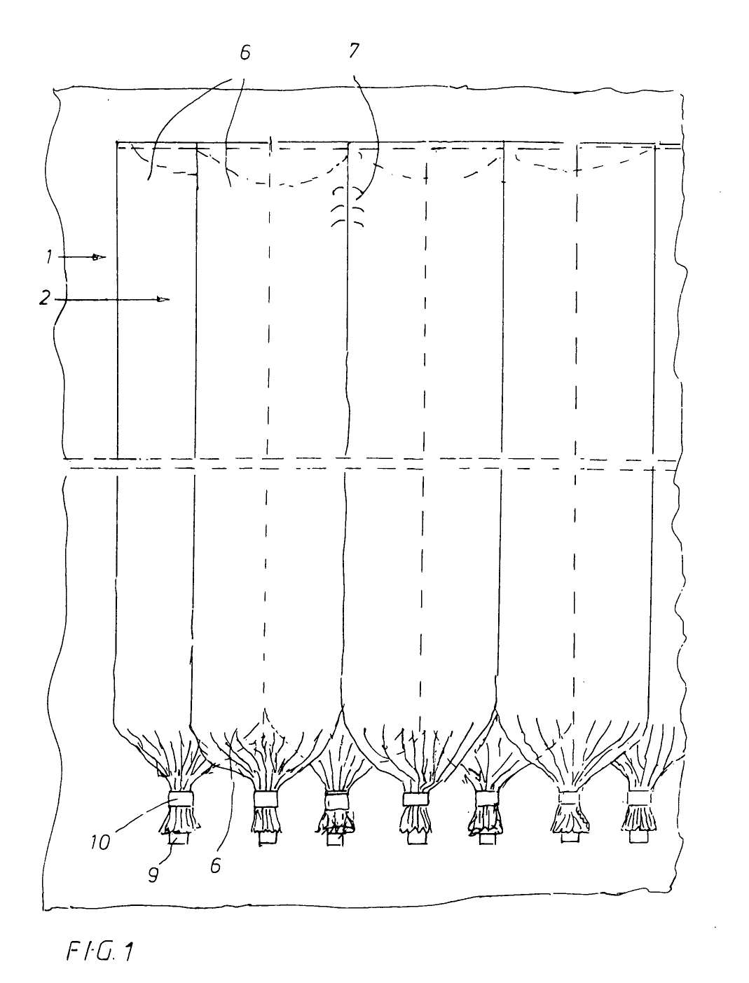

FIG. 1 shows a plan view and

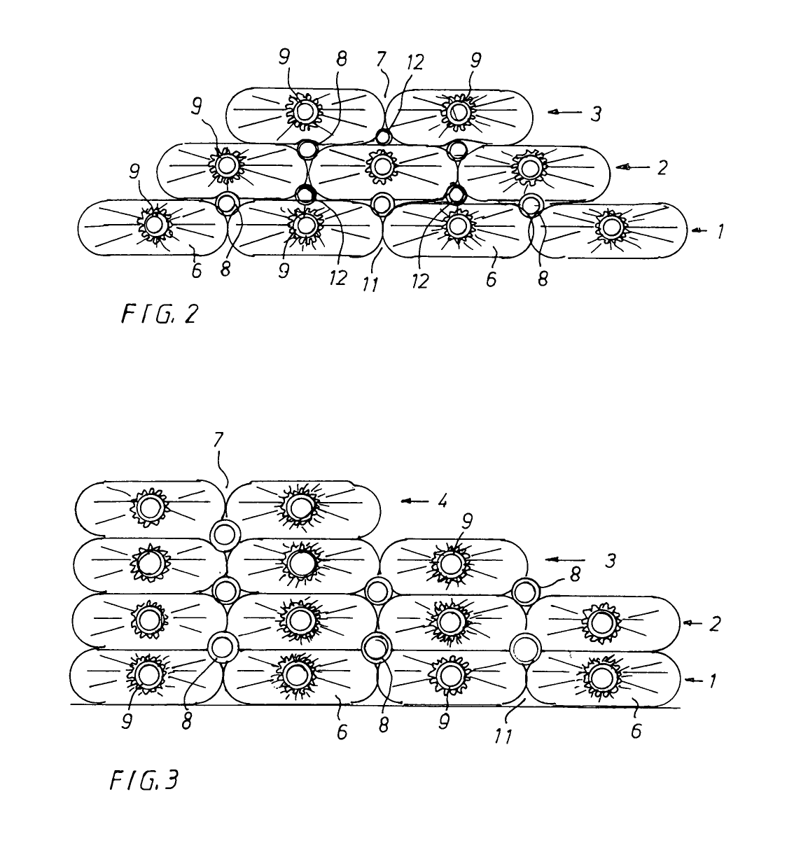

FIGS. 2 and 3 show front views of systems according to the invention for draining sludge.

FIG. 1 shows, from above, a first row 1 of hoses 6 which are located parallel to one another, and one beside the other and are filled with sludge and, above these, a second row 2 of sludge-filled hoses 6 which are located parallel to one another, and one beside the other and are offset in relation to the hoses 6 of the first row 1 by half the width of the sludge-filled hoses 6. The hoses 6 are closed at both ends. A closeable filler nozzle 9 is located at at least one end, and this nozzle can be connected to a sludge pump via a quick-action coupling. The filler nozzle 9 is retained by a tie 10 by means of which the hose 6 is closed at this end. The other end of the hose 6 can be sewn closed or also, in particular in the case of long hoses, provided with a second filler nozzle. Two sludge-filled hoses 6 located one beside the other form in each case an upwardly open channel 7. Drainage pipes 8, which extend over the length of the hoses 6, are arranged in these upwardly open channels 7, which can be seen in particular from FIG. 2, of the first row 1 and of each further row loaded with sludge-filled hoses.

As FIGS. 1 and 2 show, the sludge-filled hoses 6 are arranged such that the hoses 6 of the row 1, 2 located beneath in each case are offset by half the width of a sludge-filled hose 6. Upwardly open channels 7, into which the drainage pipes 8 are inserted, are produced on the upper side of each row 1, 2, 3 of hoses 6. The offset results in downwardly open channels 11 being produced on the underside of each row of hoses 6, it likewise being possible for drainage pipes 12 to be introduced into these downwardly open channels.

In order that the drainage pipes 12 which are intended to end up located in the downwardly open channels 11 of a row of hoses 6 located above do not slip, it may be expedient for these drainage pipes 12 to be fastened at intervals on the sludge-filled hoses 6 of the row 1, 2, 3 of hoses which is located beneath in each case.

The offset arrangement of the hoses 6 has the advantage that the assembly of rows 1, 2, 3, 4 of sludge-filled hoses 6 stacked one upon the other is stable. This is advantageous, in particular, when numerous rows of hoses are stacked one above the other.

In FIG. 3, the sludge-filled hoses 6 of rows 1, 2 and 3 are located one above the other without any offset. This has the advantage that the upwardly open channels 7 of each row 1, 2, 3 and the downwardly open channels 11 of the rows 2, 3 and 4 coincide, and therefore relatively large-diameter drainage pipes 8 can be arranged between the sludge-filled hoses 6 without the pressure to which the drainage pipes 8 is subjected by the sludge-filled hoses 6 being too great.

### LIST OF DESIGNATIONS

1 first row of sludge-filled hoses 6

2 second row of sludge-filled hoses 6

3 third row of sludge-filled hoses 6

4 fourth row of sludge-filled hoses 6

5

6 sludge-filled hose

7 upwardly open channel

8 drainage pipe

9 filler nozzle

10 tie

11 downwardly open channel

12 drainage pipe

1-16. (canceled)

17. A system for draining sludge, comprising:
water-permeable hoses, which are closed at both ends and filled with sludge, wherein a first, lower row of the sludge-filled hoses, the sludge-filled hoses being located parallel to one another and one beside the other, has arranged thereon a second row of sludge-filled hoses located parallel to one another and one beside the other; and
water-permeable elements, which extend over the length of the hoses, arranged between each row which bears at least one further row of sludge-filled hoses, wherein the water-permeable elements include drainage pipes which are introduced in upwardly open channels, which are formed in each case by two sludge-filled hoses located one beside the other.

18. The system of claim 17, wherein the second row has arranged thereon additional rows of sludge-filled hoses.

19. The system as claimed in claim 17, wherein there are no openings arranged in a region of a lower part of the drainage pipes, and wherein a wall of the drainage pipes forms a smooth channel.

20. The system as claimed in claim 17, wherein the hoses have a diameter of 0.4 to 1.6 m and the drainage pipes have a diameter of 50 mm, 100 mm or 150 mm.

21. The system as claimed in claim 17, wherein the hoses of a row of sludge-filled hoses resting on a row beneath are offset in relation to the hoses of the row located therebeneath, and wherein the drainage pipes are further arranged in downwardly open channels.

22. The system as claimed in claim 17, wherein the hoses of the rows of sludge-filled hoses located one upon the other are not offset, and wherein the drainage pipes are arranged in coinciding upwardly open channels and downwardly open channels.

23. The system as claimed in claim 17, further comprising:
spacing elements fitted between the hoses located one upon the other.

24. The system as claimed in claim 23, wherein the spacing elements include at least one of: stones, gravel, shrubbery, straw, geotextile drainage mats, strips of wood, lattice work, or bamboo sticks.

25. The system as claimed in claim 17, wherein the hoses, at at least one end, are provided with a filler nozzle, which can be connected to a sludge pump using quick-action coupling.

26. A method of draining sludge, comprising:
arranging a first row of water-permeable hoses, such that, following sludge filling of the hoses, the hoses are located parallel to one another, and one beside the other, without substantially any spacing therebetween;
arranging a second row of water-permeable hoses on the first row of sludge-filled hoses that are filled with sludge; and
arranging water-permeable elements between the first and second rows of hoses, wherein the water-permeable elements include drainage pipes that are introduced in upwardly open channels on an upper side of each row of hoses loaded with a row of sludge-filled hoses before the hoses resting on the drainage pipes are filled with sludge.

27. The method as claimed in claim 26, wherein the water-permeable hoses are substantially equal-sized.

28. The method as claimed in claim 26, wherein the hoses of a row of sludge-filled hoses resting on a row beneath are offset in relation to the hoses of the row located therebeneath, and wherein the drainage pipes are further arranged in downwardly open channels.

29. The method as claimed in claim 26, wherein the hoses of the rows of sludge-filled hoses located one upon the other are not offset, and the drainage pipes are arranged in the coinciding upwardly open channels and downwardly open channels.

30. The method as claimed in claim 26, wherein the hoses and the drainage pipes are laid in the longitudinal direction with an inclination which assists the drainage of water.

31. The method as claimed in claim 26, wherein, once the sludge filling of the hoses has been largely drained, the hoses are refilled with sludge once or twice.
